(19) United States
(12) Patent Application Publication
(10) Pub. No.: US 2026/0330066 A1
(43) Pub. Date: Oct. 22, 2026

(54) Secure Software Component Activation Through Signature-Governed Attribute Change

(71) Applicant: Oracle International Corporation, Redwood Shores, CA (US)

(72) Inventors: Rajarshi Chowdhury, San Jose, CA (US); Akshay D Shah, Foster City, CA (US); Sumanta Kumar Chatterjee, Menlo Park, CA (US); Ravi Shankar Thammaiah, Redwood City, CA (US)

(73) Assignee: Oracle International Corporation, Redwood Shores, CA (US)

(21) Appl. No.: 19/344,045

(22) Filed: Sep. 29, 2025

(51) Int. Cl. G06F 21/64; G06F 21/60

(52) U.S. Cl. CPC G06F 21/64; G06F 21/602

(57) ABSTRACT

Techniques for securely updating root-owned files on a computer system are disclosed. The system includes an enabler component that acts as an intermediary between the user and the root-owned files, allowing non-root users to initiate update operations without requiring manual intervention by a root user. The system uses a manifest file, which is signed with a digital signature, to validate the integrity and authenticity of the replacement files. The manifest file comprises hashes of each replacement file as well as information about the permissions and ownership of the files. The system verifies the digital signature of the manifest file using a public key and checks the hashes of the replacement files to ensure that they match the expected values. If these checks and others pass validation, the enabler replaces the root owned files on behalf of the non-root user.

### TECHNICAL FIELD

The present disclosure relates to update management systems. In particular, the present disclosure relates to securely updating root-owned files on a system.

### BACKGROUND

Updating root-owned files on a system typically involves the use of specific permissions and access controls to prevent unauthorized changes. System administrators use a variety of methods to update root-owned files, including command-line interfaces and graphical user interfaces (GUIs). The updates can be performed manually or through automated scripts, depending on the specific needs of the system. In some cases, updates may be performed as part of a larger system maintenance or upgrade process. The process of updating root-owned files is an important part of system administration.

Key rotation is another important process that involves updating cryptographic keys used for authentication and encryption. These keys are used to secure sensitive data and ensure the integrity of the system. System administrators are responsible for managing and rotating these keys to ensure the security and integrity of the system. Key rotation involves generating new keys, updating configurations to reference the new keys, and retiring old keys. This process is typically performed on a regular basis to ensure the security of the system. In some cases, key rotation may be performed as part of a larger system maintenance or upgrade process.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for updating root-owned files in accordance with one or more embodiments;

FIG. 3 illustrates an example set of operations for offline key rotation in accordance with one or more embodiments;

FIG. 4 illustrates an example set of operations for mitigating time-of-check/time-of-use (TOCTOU) attacks on public keys in accordance with one or more embodiments;

FIG. 5 illustrates an example set of operations for mitigating TOCTOU attacks after signature verification in accordance with one or more embodiments;

FIG. 6 illustrates an example set of operations for updating root-owned files in accordance with one or more embodiments;

FIG. 7 illustrates an example set of operations for key rotation in accordance with one or more embodiments; and

FIG. 8 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. UPDATE MANAGEMENT SYSTEM ARCHITECTURE
3. UPDATING ROOT-OWNED FILES
4. OFFLINE KEY ROTATION
5. MITIGATING TOCTOU ATTACKS
6. EXAMPLE EMBODIMENTS
7. PRACTICAL APPLICATIONS, ADVANTAGES, AND IMPROVEMENTS
8. COMPUTER NETWORKS AND CLOUD NETWORKS
9. HARDWARE OVERVIEW
10. MISCELLANEOUS; EXTENSIONS

### 1. GENERAL OVERVIEW

One or more embodiments receive requests from non-root users to update root-owned files. The system updates root-owned files without requiring manual intervention by a root user. This is achieved through a system that allows for secure key rotation and file updating even in offline scenarios. The method involves receiving instructions from a non-root user to perform an update operation, accessing a file package that includes a manifest file and replacement files, and performing a validation operation to ensure the integrity and authenticity of the replacement files. The validation operation checks the digital signature of the manifest file and verifies that the replacement files match the hashes listed in the manifest file. If the validation operation is successful, the method updates the root-owned files by replacing them with the replacement files. This ensures that the root-owned files are updated securely and efficiently even in the absence of a network connection.

Embodiments further provide a secure method for rotating keys that ensures that key pairs are updated securely and efficiently even in the absence of a network connection. The method involves accessing a new public key and a signature generated using an old private key, verifying the signature to determine if the new public key is authentic, and replacing the old public key with the new public key. The verification process checks the digital signature of the new public key and ensures that it matches the old public key. If the verification process is successful, the method replaces the old public key with the new public key, ensuring that the key pair is updated securely and efficiently. The method can be performed in an offline environment without requiring a network connection, making it particularly useful in scenarios where network connectivity is unreliable or unavailable. The system ensures that key pairs are updated securely and efficiently even in the absence of a network connection. Unless a key in the chain is found in a blacklist, a similar process id followed in the case of a rollback or downgrade operation. This ensures that the public key chain is valid.

One or more embodiments described in this Specification and/or recited in the claims may not be included in this General Overview section.

### 2. UPDATE MANAGEMENT SYSTEM ARCHITECTURE

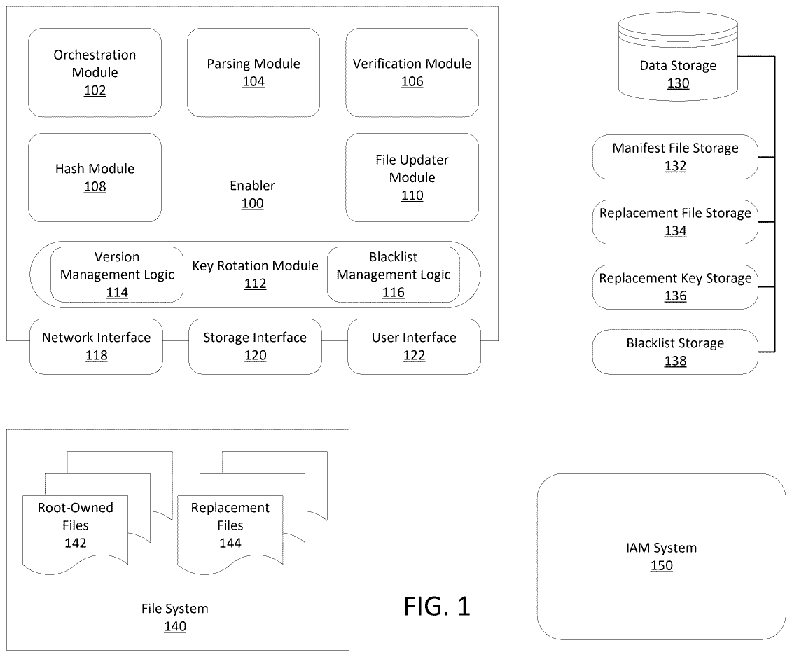

FIG. 1 illustrates a secure update system in accordance with one or more embodiments. As illustrated in FIG. 1, enabler 100 includes orchestration module 102, parsing module 104, verification module 106, hash module 108, file updater module 110, network interface 118, storage interface 120, and user interface 122. Data storage 130 includes manifest file storage 132, replacement file storage 134, replacement key storage 136, and blacklist storage 138. In an embodiment, enabler 100 is an intermediary that supports secure updates to root-owned files by helping non-root users perform update operations. Enabler 100 receives instructions from non-root users to perform update operations on root-owned files. Enabler 100 accesses file packages that comprise manifest files and replacement files. The file packages are obtained from data storage 130 using storage interface 120. Enabler 100 performs validation operations on the manifest files to ensure their integrity and authenticity.

In an embodiment, enabler 100 is a component that facilitates secure updates to root-owned files. Enabler 100 comprises a validation module that accesses and validates file packages that comprise manifest files and replacement files that are stored in data storage 130. The manifest files comprise information about the replacement files, including their hashes and sizes. Enabler 100 also comprises a permission module that interacts with IAM system 150 to determine if an update operation is allowed. The permission module uses permission information from IAM system 150 to ensure that the update operation is performed with proper permissions.

In an embodiment, enabler 100 interacts with file system 140 to replace root-owned files with replacement files. Enabler 100 uses the information in the manifest file to identify the replacement files and update the root-owned files accordingly. Enabler 100 also interacts with data storage 130 to retrieve the replacement files and manifest files. The interaction between enabler 100 and file system 140 is facilitated by a file access module that manages the transfer of data between the two components.

In an embodiment, enabler 100 is configured to work with IAM system 150 to manage permissions associated with files and directories. Enabler 100 uses permission information from IAM system 150 to determine if an update operation is allowed. Enabler 100 also interacts with IAM system 150 to retrieve permission information and to update the permissions associated with the root-owned files. The interaction between enabler 100 and IAM system 150 may be facilitated by a permission management module or other logic, depending on the type of IAM system used, that manages the transfer of permission information between the two components.

In an embodiment, orchestration module 102 is a component that manages the flow of the update process. Orchestration module 102 comprises a workflow management module that defines the sequence of operations involved in the update process. The workflow management module ensures that the operations are performed in the correct order and that the update process is completed successfully. Orchestration module 102 interacts with parsing module 104 to validate the update operation and ensure that the files are valid. Orchestration module 102 also interacts with verification module 106 to determine if the update operation is allowed.

In an embodiment, orchestration module 102 receives input from parsing module 104 and verification module 106 and uses this information to determine the next step in the update process. Orchestration module 102 interacts with data storage 130 to retrieve the replacement files and manifest files. Orchestration module 102 also interacts with file system 140 to update the root-owned files. The interaction between orchestration module 102 and other components is facilitated by a communication module that manages the transfer of data and instructions between the components.

In an embodiment, orchestration module 102 manages the transfer of data between components, such as data storage 130 and file system 140. Orchestration module 102 ensures the data is transferred correctly, and the update process is completed successfully. Orchestration module 102 interacts with IAM system 150 to retrieve permission information and to update the permissions associated with the root-owned files. The interaction between orchestration module 102 and IAM system 150 is facilitated by a permission management module that manages the transfer of permission information between the two components.

In an embodiment, parsing module 104 is a component that parses the manifest file and extracts relevant information. Parsing module 104 comprises a parsing algorithm that analyzes the manifest file and identifies the relevant information, such as the hashes and sizes of the replacement files. Parsing module 104 interacts with data storage 130 to retrieve the manifest file and extract the relevant information. The parsing algorithm ensures the information is extracted correctly, and the manifest file is parsed successfully.

In an embodiment, parsing module 104 uses a specific parsing technique, such as XML parsing, to extract the relevant information from the manifest file. Parsing module 104 interacts with verification module 106 to validate the extracted information, ensuring that it is correct. Parsing module 104 also interacts with orchestration module 102 to provide the extracted information and facilitate the update process. The interaction between parsing module 104 and other components is facilitated by a communication module that manages the transfer of data and instructions between the components. For added security, the manifest can be encoded or encrypted and the parser should have the logic to decode or decrypt before reading the contents.

In an embodiment, verification module 106 is a component that verifies the signature of the manifest file. Verification module 106 comprises a signature verification algorithm that analyzes the manifest file and verifies its signature. Verification module 106 interacts with data storage 130 to retrieve the manifest file and verify its signature. The signature verification algorithm ensures the signature is valid, and the manifest file has not been tampered with.

In an embodiment, verification module 106 uses a specific signature verification technique, such as RSA or ECDSA, to verify the signature of the manifest file. Verification module 106 interacts with orchestration module 102 to provide the verification results and facilitate the update process. Verification module 106 also interacts with parsing module 104 to validate the extracted information and ensure it is correct. The interaction between verification module 106 and other components is facilitated by a communication module that manages the transfer of data and instructions between the components. If the manifest has been tampered with, the verification fails, in which case the verification module may log, notify or queue the failure-related information for immediate or later security review.

In an embodiment, hash module 108 is a component that computes hashes of replacement files. Hash module 108 comprises a hashing algorithm that analyzes the replacement files and computes their hashes. Hash module 108 interacts with data storage 130 to retrieve the replacement files and compute their hashes. The hashing algorithm ensures the hashes are computed correctly, and the replacement files are accurately identified. Hash module 108 also interacts with verification module 106 to verify the hashes and ensure the replacement files are valid. The interaction between hash module 108 and other components is facilitated by a communication module that manages the transfer of data and instructions between the components.

In an embodiment, hash module 108 uses a specific hashing algorithm, such as SHA-256 or MD5, to compute the hashes of the replacement files. Hash module 108 interacts with file system 140 to retrieve the replacement files and compute their hashes. Hash module 108 also interacts with IAM system 150 to retrieve permission information and ensure the update operation is allowed. The interaction between hash module 108 and other components is facilitated by a communication module that manages the transfer of data and instructions between the components.

In an embodiment, file updater module 110 is a component that updates root-owned files. File updater module 110 comprises an updating algorithm that analyzes the replacement files and updates the root-owned files accordingly. File updater module 110 interacts with data storage 130 to retrieve the replacement files and update the root-owned files. The updating algorithm ensures the updates are performed correctly, and the root-owned files are accurately updated. File updater module 110 also interacts with hash module 108 to verify the hashes of the replacement files and ensure they are valid.

In an embodiment, file updater module 110 uses a specific updating algorithm, such as copy or replace, to update the root-owned files. File updater module 110 interacts with file system 140 to update the root-owned files and ensures they are accurately updated. File updater module 110 also interacts with IAM system 150 to retrieve permission information and ensures that the update operation is allowed. The interaction between file updater module 110 and other components is facilitated by a communication module that manages the transfer of data and instructions between the components.

In an embodiment, key rotation module 112 is a component that manages key rotation operations. Key rotation module 112 comprises version management logic 114 and blacklist management logic 116. Version management logic 114 ensures that the proper version of the key is used, while blacklist management logic 116 checks the blacklist to ensure that a compromised key is not used and adds bad keys to the blacklist. Key rotation module 112 interacts with data storage 130 to retrieve the key and manage the key rotation operations. The key rotation operation involves rotating the key to ensure the key is updated, and the previous key is no longer used. Key rotation module 112 also interacts with IAM system 150 to retrieve permission information and ensure the key rotation operation is allowed. The interaction between key rotation module 112 and other components is facilitated by a communication module that manages the transfer of data and instructions between the components.

In an embodiment, key rotation module 112 uses a specific algorithm to manage the key rotation operations, such as RSA or ECDSA. Key rotation module 112 interacts with data storage 130 to retrieve the key and manage the key rotation operations. The key rotation operation involves updating the key to ensure the key is updated, and the previous key is no longer used. Key rotation module 112 also interacts with IAM system 150 to retrieve permission information and ensure the key rotation operation is allowed. The interaction between key rotation module 112 and other components is facilitated by a communication module that manages the transfer of data and instructions between the components. Key rotation module 112 also interacts with logging module 118 to log the key rotation operation and ensure the operation is tracked and monitored.

In an embodiment, version management logic 114 is responsible for ensuring that the proper version of the key is used. Version management logic 114 interacts with data storage 130 to retrieve the key and verify its version. Version management logic 114 also interacts with key rotation module 112 to ensure the key rotation operation is performed correctly. The version management logic ensures the key is updated to the correct version, and the previous version is no longer used. Version management logic 114 also interacts with IAM system 150 to retrieve permission information and ensure the key rotation operation is allowed. The interaction between version management logic 114 and other components is facilitated by a communication module that manages the transfer of data and instructions between the components.

In an embodiment, version management logic 114 uses a specific algorithm to verify the version of the key, such as a checksum or digital signature. Version management logic 114 interacts with data storage 130 to retrieve the key and verify its version. The version management logic ensures the key is updated to the correct version, and the previous version is no longer used. Version management logic 114 also interacts with IAM system 150 to retrieve permission information and ensure the key rotation operation is allowed. The interaction between version management logic 114 and other components is facilitated by a communication module that manages the transfer of data and instructions between the components. Version management logic 114 also interacts with logging module 118 to log the key rotation operation and ensure the operation is tracked and monitored.

In an embodiment, blacklist management logic 116 is responsible for checking the blacklist to ensure that a compromised key is not used, and for adding bad keys to the blacklist. Blacklist management logic 116 interacts with data storage 130 to retrieve the blacklist and check for compromised keys. Blacklist management logic 116 also interacts with key rotation module 112 to ensure the key rotation operation is performed correctly. The blacklist management logic ensures the key is updated to the correct version, and the previous version is no longer used. Blacklist management logic 116 also interacts with IAM system 150 to retrieve permission information and ensure the key rotation operation is allowed. The interaction between blacklist management logic 116 and other components is facilitated by a communication module that manages the transfer of data and instructions between the components.

In an embodiment, blacklist management logic 116 uses a specific algorithm to check for compromised keys, such as a hash function or digital signature. Blacklist management logic 116 interacts with data storage 130 to retrieve the key and check for compromised keys. The blacklist management logic ensures the key is updated to the correct version, and the previous version is no longer used. Blacklist management logic 116 also interacts with IAM system 150 to retrieve permission information and ensure the key rotation operation is allowed. The interaction between blacklist management logic 116 and other components is facilitated by a communication module that manages the transfer of data and instructions between the components. Blacklist management logic 116 also interacts with logging module 118 to log the key rotation operation and ensure the operation is tracked and monitored.

Network interface 118 is responsible for allowing communication with remote servers to retrieve file packages. Network interface 118 interacts with data storage 130 to retrieve the file packages and ensure they are properly formatted and authenticated. Network interface 118 also interacts with IAM system 150 to retrieve permission information and ensure the file packages are retrieved correctly. The interaction between network interface 118 and other components is facilitated by a communication module that manages the transfer of data and instructions between the components.

Storage interface 120 is responsible for allowing access to stored files and data. Storage interface 120 interacts with data storage 130 to retrieve and store the files and data. Storage interface 120 also interacts with IAM system 150 to retrieve permission information and ensure the files and data are accessed correctly. The interaction between storage interface 120 and other components is facilitated by a communication module that manages the transfer of data and instructions between the components.

User interface 122 is responsible for allowing non-root users to initiate update operations. It provides a means for users to interact with the system and request updates to root-owned files. User interface 122 can be configured in various ways to accommodate different user preferences and requirements. For example, it can be implemented as a web interface, allowing users to access the system through a web browser and initiate updates through a graphical user interface.

In addition to a web interface, user interface 122 can also be configured as an API, allowing users to interact with the system programmatically. This can be particularly useful for automated systems or scripts that need to initiate updates on a regular basis. The API can be designed to provide a set of commands or methods that can be used to initiate updates as well as to retrieve information about the system and its configuration.

User interface 122 can also be configured to provide a command-line interface, allowing users to interact with the system through a terminal or command-line prompt. This can be particularly useful for users who are familiar with command-line interfaces and prefer to work in a terminal. The command-line interface can provide a set of commands or options that can be used to initiate updates, as well as to retrieve information about the system and its configuration. Overall, user interface 122 provides a flexible and customizable way for non-root users to interact with the system and initiate updates to root-owned files.

In an embodiment, one or more cloud interfaces may be implemented to facilitate system operations and management. The cloud interfaces may comprise a variety of interface types, including but not limited to cloud orchestration interfaces, application programming interfaces (APIs), web service interfaces, and management console interfaces. In a particular embodiment, the user interface may be implemented as a cloud orchestration interface that provides centralized control and coordination of distributed cloud resources and services. The cloud orchestration interface may be configured to present a unified management view of heterogeneous infrastructure components, enabling streamlined administration of complex distributed systems. In certain implementations, the infrastructure provisioning and maintenance operations can be dynamically invoked through cloud orchestration modules, which may be configured to automatically install software patches, security updates, configuration changes, and other system modifications across multiple nodes or instances within the cloud environment. The cloud orchestration modules may further comprise scheduling capabilities, dependency management, rollback mechanisms, and verification procedures to ensure reliable and consistent patch deployment across the distributed infrastructure while minimizing service disruption and maintaining system availability.

In an embodiment, data storage 130 uses a specific storage mechanism, such as a database or file system, to store the files and data. Data storage 130 interacts with IAM system 150 to retrieve permission information and ensure that the files and data are accessed correctly. The interaction between data storage 130 and IAM system 150 is facilitated by a communication module that manages the transfer of data and instructions between the components. Data storage 130 also interacts with key rotation module 112 to retrieve and store the public keys and blacklisted public keys.

In one or more embodiments, data storage 130 is any type of storage unit and/or device (e.g., a file system, database, collection of tables, or any other storage mechanism) for storing data. Furthermore, a data storage 130 may include multiple different storage units and/or devices. The multiple different storage units and/or devices may or may not be of the same type or located at the same physical site. Furthermore, a data storage 130 may be implemented or executed on the same computing system as enabler 1100. Additionally, or alternatively, a data storage 130 may be implemented or executed on a computing system separate from enabler 100. The data storage 130 may be communicatively coupled to enabler 100 via a direct connection or via a network. Information describing enabler may be implemented across any of the components within enabler 100. However, this information is illustrated within the data storage 130 for purposes of clarity and explanation.

In an embodiment, manifest file storage 132 is a component that stores manifest files that comprise information about the replacement files and their corresponding hashes. Manifest file storage 132 interacts with enabler 100 to retrieve and store the manifest files, and manifest storage 132 interacts with IAM system 150 to retrieve permission information and ensure that the manifest files are accessed correctly. The interaction between manifest file storage 132 and enabler 100 is facilitated by a communication module that manages the transfer of data and instructions between the components. Manifest file storage 132 uses a specific storage mechanism, such as a database or file system, to store the manifest files.

In an embodiment, replacement file storage 134 is a component that stores replacement files that are used to update the root-owned files. Replacement file storage 134 interacts with enabler 100 to retrieve and store the replacement files, and replacement file storage 134 interacts with IAM system 150 to retrieve permission information and ensure that the replacement files are accessed correctly. The interaction between replacement file storage 134 and enabler 100 is facilitated by a communication module that manages the transfer of data and instructions between the components. Replacement file storage 134 uses a specific storage mechanism, such as a database or file system, to store the replacement files.

In an embodiment, public key storage 136 is a component that stores public keys that are used for authentication and verification. Public key storage 136 interacts with key rotation module 112 to retrieve and store the public keys, and public key storage 136 interacts with IAM system 150 to retrieve permission information and ensure that the public keys are accessed correctly. The interaction between public key storage 136 and key rotation module 112 is facilitated by a communication module that manages the transfer of data and instructions between the components. Public key storage 136 uses a specific storage mechanism, such as a database or file system, to store the public keys.

In an embodiment, blacklist storage 138 is a component that stores blacklisted public keys that have been compromised and are no longer trusted. Blacklist storage 138 interacts with key rotation module 112 to retrieve and store the blacklisted public keys, and blacklist storage 138 interacts with IAM system 150 to retrieve permission information and ensure that the blacklisted public keys are accessed correctly. The interaction between blacklist storage 138 and key rotation module 112 is facilitated by a communication module that manages the transfer of data and instructions between the components. Blacklist storage 138 uses a specific storage mechanism, such as a database or file system, to store the blacklisted public keys.

In an embodiment, file system 140 is a storage component that stores and manages files. File system 140 interacts with enabler 100 to retrieve and store files, and file system 140 interacts with IAM system 150 to retrieve permission information and ensure that the files are accessed correctly. The interaction between file system 140 and enabler 100 is facilitated by a communication module that manages the transfer of data and instructions between the components. File system 140 uses a specific storage mechanism, such as a file system or database, to store the files.

In an embodiment, file system 140 provides a hierarchical structure for storing and organizing files. File system 140 allows for the creation of directories and subdirectories and enables the storage of files in a logical and organized manner. File system 140 also provides mechanisms for searching, retrieving, and updating files as well as for managing file permissions and access controls. The interaction between file system 140 and other components is facilitated by a communication module that manages the transfer of data and instructions between the components.

In an embodiment, root-owned files 142 are files that require root-level access to change, replace, or update. These files are typically critical system files that are used to manage the system's configuration, settings, or functionality. Root-owned files 142 are stored in file system 140 and are managed by enabler 100. The interaction between root-owned files 142 and enabler 100 is facilitated by a communication module that manages the transfer of data and instructions between the components.

In an embodiment, root-owned files 142 are protected by access controls that ensure only authorized users with root-level access can modify or update the files. These access controls are implemented through IAM system 150, which manages the permissions and access rights for users and groups. The interaction between root-owned files 142 and IAM system 150 is facilitated by a communication module that manages the transfer of data and instructions between the components.

In an embodiment, replacement files 144 are files that are intended to replace root-owned files 142. These files are typically updated versions of the root-owned files and are used to update the system's configuration, settings, or functionality. Replacement files 144 are stored in file system 140 and managed by enabler 100. The interaction between replacement files 144 and enabler 100 is facilitated by a communication module that manages the transfer of data and instructions between the components.

In an embodiment, replacement files 144 are used to update root-owned files 142 when a new version of the file is available. The replacement files are stored in file system 140 and retrieved by enabler 100 when a request is made to update the root-owned files. The interaction between replacement files 144 and enabler 100 is facilitated by a communication module that manages the transfer of data and instructions between the components.

In an embodiment, replacement files 144 are validated by verification module 106 before being used to update root-owned files 142. The verification module checks the integrity and authenticity of the replacement files to ensure they are valid and can be trusted. The interaction between replacement files 144 and verification module 106 is facilitated by a communication module that manages the transfer of data and instructions between the components.

In an embodiment, IAM system 150 is a component that manages the permissions associated with the files and directories in the system. IAM system 150 is responsible for ensuring only authorized users have access to the files and directories, and the permissions are properly configured to ensure the security and integrity of the system. IAM system 150 interacts with enabler 100 to retrieve and store permission information, and IAM system 150 interacts with file system 140 to manage the permissions associated with the files and directories. The interaction between IAM system 150 and enabler 100 is facilitated by a communication module that manages the transfer of data and instructions between the components.

In an embodiment, IAM system 150 uses a specific permission model to manage the permissions associated with the files and directories. The permission model defines the different levels of access that users can have to the files and directories, such as “root-owned” or “non-root user.” IAM system 150 uses this permission model to determine which users have access to which files and directories and to ensure that the permissions are properly configured to ensure the security and integrity of the system. The interaction between IAM system 150 and the permission model is facilitated by a communication module that manages the transfer of data and instructions between the components.

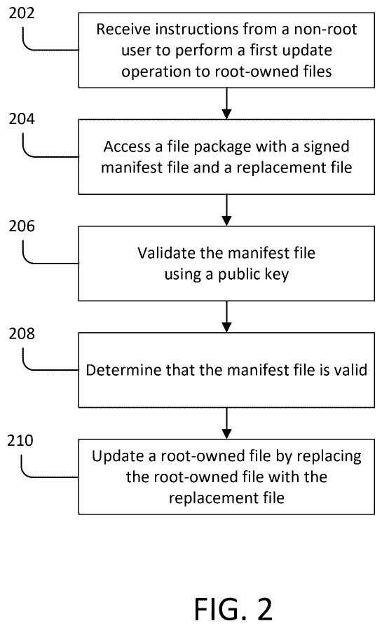

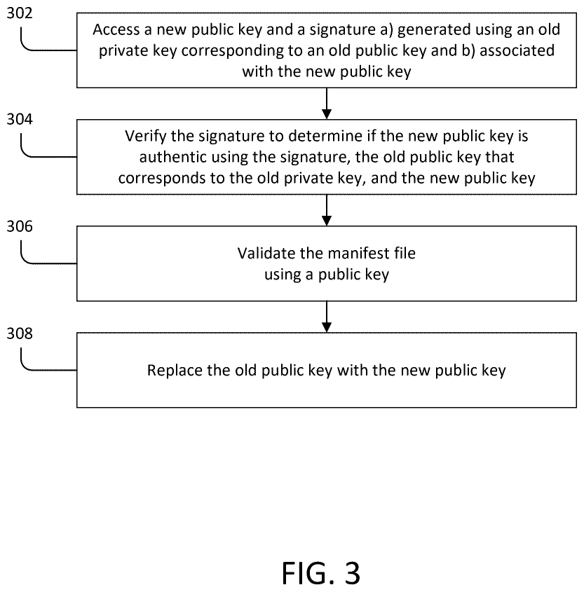

In one or more embodiments, enabler 100 refers to hardware and/or software configured to perform operations described herein for enabler 100. Examples of operations for enabler 100 are described below with reference to FIGS. 2 and 3.

In an embodiment, enabler 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. UPDATING ROOT-OWNED FILES

FIG. 2 illustrates an example set of operations for updating root-owned files in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system receives instructions from a non-root user to perform a first update operation to root-owned files (Operation 202). This instruction is received through a user interface, such as a web interface or command-line interface, and is processed by the system's enabler component. The enabler component interacts with the IAM system to verify the user's permissions and ensure that they have the necessary access to initiate the update operation. Despite being a non-root user, the user can initiate the update operation through the enabler component that acts as an intermediary between the user and the root-owned files.

In an embodiment, the first update operation comprises replacing root-owned files with replacement files stored in a file package. Replacement files may correspond to the root-owned files they are meant to replace. In other words, replacement files are specifically designed to update the root-owned files and may be identical to the root-owned files they are meant to replace. This ensures the update operation is performed correctly, and the root-owned files are updated with the latest version. The file package that comprises the replacement files is accessed by the system and prepared for the update operation. The system then retrieves the replacement files from the file package and begins the update process. The update process involves replacing the root-owned files with the replacement files, ensuring that the system is updated with the latest version.

In an embodiment, the system accesses a file package with a signed manifest file and a replacement file (Operation 204). In an embodiment, the manifest file is signed with a signature that corresponds to a private key. The file package can be obtained from a remote server or a local storage device. The file package comprises a signed manifest file and a replacement file. The manifest file includes a hash of each of the files, their size, the ultimate user ID (UID) they want to be, and the permissions they want to have. For example, the manifest file may specify that a particular file has a hash of “abc 123,” a size of 1024 bytes, and wants to be owned by the root user with read, write, and execute permissions. The manifest file is signed with a signature that corresponds to a private key. The private key is securely stored with the enterprise, and a corresponding public key is published and made available for verification. The signed manifest file provides a secure and verifiable way to ensure that the replacement files are authentic and trustworthy. The manifest file is a critical component of the file package, for it provides the necessary information to perform the update operation securely and efficiently.

In an embodiment, the system validates the manifest file using a public key (Operation 206). The system compares the signature with a public key corresponding to the private key. This verification process ensures that the manifest file has not been tampered with or altered during transmission. The system uses the public key to verify the signature that provides a secure and reliable way to ensure the authenticity of the manifest file. The verification process is a critical step in the update operation, for it ensures that the replacement files are genuine and trustworthy.

In an embodiment, the system performs a series of checks to ensure that the manifest file is valid and has not been altered during transmission. The system checks the digital signature of the manifest file that provides a secure way to verify the authenticity of the file. The system also checks the contents of the manifest file, including the hashes and sizes of the replacement files, to ensure that they match the expected values. By verifying the integrity of the manifest file, the system ensures the update operation is performed securely and efficiently. The verification process provides a secure and reliable way to ensure the replacement files are authentic and trustworthy.

In an embodiment, the system determines that the manifest file is valid (Operation 208). The system passes the checks, including verification of the digital signature, hash checks, and size checks. The system's validation module confirms the manifest file has not been tampered with, and its contents are accurate. The system verifies the signature of the manifest file matches the expected signature, and the hashes and sizes of the replacement files match the expected values. With checks passed, the system determines that the manifest file is valid and proceeds to the next step of the update operation.

In an embodiment, the system updates a root-owned file by replacing the root-owned file with the replacement file (Operation 210). During the replacement process, the system uses the information in the validated manifest file to identify the root-owned file to be updated and the corresponding replacement file. The system then replaces the root-owned file with the replacement file, ensuring that the file is updated with the correct permissions and ownership. The replacement process involves updating the file's metadata, such as its user ID, group ID, and permissions, to match the values specified in the manifest file. The system also verifies that the replacement file has the correct hash and size, ensuring that the update is performed correctly. With the replacement process complete, the root-owned file is updated, and the system ensures the file has the correct permissions and ownership. The updated file is then ready for use, and the system can proceed with any further operations.

In an embodiment, the system uses the information in the validated manifest file to identify the root-owned file to be updated and the corresponding replacement file. The manifest file comprises hashes of each of the replacement files that are used to verify the integrity of the files. The system calculates the hash of each replacement file and compares it with the corresponding hash in the manifest file. If the hashes match, the system proceeds with the replacement process. The system also verifies the replacement file has the correct size as specified in the manifest file. The replacement process involves updating the file's metadata, such as its user ID, group ID, and permissions, to match the values specified in the manifest file. The system updates the root-owned file with the replacement file that has been verified to be authentic and correct.

In an embodiment, the system uses the hashes in the manifest file to ensure that the replacement files have not been tampered with or altered during or after transmission. The system calculates the hash of each replacement file and compares it with the corresponding hash in the manifest file. If the hashes do not match, the system aborts the replacement process and reports an error. If the hashes match, the update process continues.

In an embodiment, the system performs a validation operation on a second file. The manifest file is associated with a private key and a public key. The system determines permissions associated with the public key corresponding to the private key. The system checks if the public key is a root-owned file. If the public key is a root-owned file, the system may allow the update operation to proceed. However, if the public key is not a root-owned file, the system terminates the second validation operation.

In an embodiment, the system ensures that only secure and trusted public keys are used for the update operation. The validation operation is an additional security check to prevent unauthorized access to the system. The system supports multiple validation operations to ensure the security and integrity of the update process. The system performs the validation operation using the information in the manifest file. The system uses the second public key to determine the permissions associated with it. The system makes a determination based on the permissions associated with the second public key.

In an embodiment, the system opens a file descriptor for replacement files identified in the manifest file. This is done to prevent Time of Check to Time of Use (TOCTOU) attacks, where an attacker attempts to swap out the file with a malicious one between the time the file is checked and the time it is used. By opening a file descriptor, the system ensures that it is working with the original file even if an attacker attempts to replace it with a different file. The file descriptor remains in memory, allowing the system to continue working with the original file even if the underlying file on disk is replaced. This provides a secure way for the system to access and update the root-owned files.

In an embodiment, the system uses the file descriptor to update the root-owned file. The file descriptor ensures the system is working with the original file, and any changes made to the file on disk do not affect the file descriptor. The system writes the replacement file to the correct location and ensures the file has the correct permissions and ownership. The system verifies the replacement file has been written correctly, and the file has the correct metadata. The file descriptor is then closed, and the update operation is complete. This approach prevents an attacker from replacing the file with a malicious one after the file has been checked but before it is used. The system is able to update the root-owned file securely and efficiently without being vulnerable to TOCTOU attacks. The use of file descriptors provides a secure way to access and update the root-owned files. The system supports multiple file descriptors, allowing it to update multiple files simultaneously.

In an embodiment, the enabler possesses root privileges, whereas the user initiating the update operation does not. This disparity in privileges is a deliberate design choice, for it allows the enabler to perform sensitive operations on behalf of the user without granting the user direct access to the root-owned files. When a user downloads files to replace the root-owned files, the files are initially owned by the user, reflecting the user's privileges. However, after the enabler performs the verification steps, including validating the digital signatures and hashes of the replacement files, the enabler swaps out the files, and the files become root-owned. This change in ownership ensures the updated files have the correct permissions and access controls.

The enabler's ability to update root-owned files on behalf of a non-root user is a significant advantage over traditional update methods that often require the involvement of a system administrator. By leveraging the enabler's root privileges, the system can perform updates to root-owned files without requiring the user to have direct access to the files or to escalate the user's privileges. This approach streamlines the update process, reducing the need for manual intervention and minimizing the risk of errors or security breaches. Furthermore, the enabler's verification steps ensure the replacement files are authentic and trustworthy, providing an additional layer of security and assurance.

In an embodiment, the enabler's role as an intermediary allows the enabler to act as a trusted proxy for a root user, performing sensitive operations on behalf of the root user while maintaining the security and integrity of the system. The system's design ensures the update process is both secure and efficient, allowing non-root users to update root-owned files without compromising the system's security or requiring manual intervention. The enabler's root privileges allow the enabler to perform the necessary operations to update the root-owned files, whereas the non-root user's lack of privileges prevents non-root users from accessing or modifying the files directly. The enabler can perform these actions on behalf of the non-root user, allowing non-root users to update root-owned files without escalation. The non-root user will not be able to delete or modify the root-owned files directly, but the enabler can do so on behalf of a root user.

In an embodiment, the enabler is capable of updating itself using the same techniques that it uses to update other root-owned files. During the initial installation, a root-owned script renames the enabler binary file to “enabler” and sets the proper user and permissions. This ensures that the enabler has the necessary privileges to perform its functions. The enabler's ability to update itself ensures the security and integrity of the system while allowing updates to be performed without administrative intervention. The enabler's update process is similar to the process used to update other root-owned files but uses a temporary file and renaming process instead.

In an embodiment, when a patching process is initiated, the system checks for the existence of the enabler binary and verifies that the enabler binary has the proper user and permissions. If the enabler binary is not present or does not have the correct permissions, the patching process will not proceed. The system performs a series of checks to ensure that the enabler binary is valid and can be updated. The enabler's permissions are updated along with other binaries during the patching process. The enabler's update process involves renaming the new enabler. bin file to enabler. The enabler's ability to update itself ensures the system remains secure and up-to-date.

### 4. OFFLINE KEY ROTATION

FIG. 3 illustrates an example set of operations for offline key rotation in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

In an embodiment, the system accesses a new public key and a signature that is a) generated using an old private key corresponding to an old public key and b) associated with the new public key (Operation 302). The system retrieves the new public key and signature from a file package that comprises a manifest file, a replacement file, and other relevant information previously discussed in connection with manifest files. The file package can be obtained from a remote server or a local storage device, such as a database or file system. The key may also be part of a package of other files that need to be updated. For example, an update package may be signed with a key that is not known to the system, requiring the key rotation to take place before the files can be verified. The system checks that the new public key and signature are present and in the correct format. The signature is generated using the old private key that corresponds to the old public key. The old private key is securely stored with the enterprise. The corresponding old public key is used for later verification.

In an embodiment, the system verifies the signature to determine if the new public key is authentic using the signature, the old public key that corresponds to the old private key, and the new public key (Operation 304). The system performs a verification operation to ensure the signature was generated using the old private key. The verification operation involves using a cryptographic algorithm to verify the signature. The system checks that the signature is valid and corresponds to the old private key. The system also checks that the new public key is correctly formatted and matches the expected values. The verification operation ensures that the new public key is authentic and trustworthy. The system uses the old public key to verify the signature and then uses the new public key to ensure the signature is correctly formatted and valid. The system ensures the new public key is authentic and trustworthy before proceeding with the key rotation operation.

In an embodiment, the system validates the manifest file using a public key (Operation 306). The system performs a validation operation to ensure the manifest file has not been tampered with or altered during transmission. The validation operation involves verifying the digital signature of the manifest file using the public key. The system checks that the digital signature is valid and corresponds to the expected signature. The system also checks that the manifest file has not been modified or corrupted during transmission. The validation operation ensures the manifest file is authentic and trustworthy. The system uses the public key to verify the digital signature of the manifest file and then uses the validated manifest file to ensure that the update operation is performed correctly.

In an embodiment, the system replaces the old public key with the new public key (Operation 308). The system updates the public key storage with the new public key. The old public key is no longer used and is replaced by the new public key. The system ensures that the new public key is correctly stored and managed. The replacement of the old public key with the new public key is a critical step in the key rotation process. The system performs the replacement operation securely and efficiently. The new public key is used for future verification operations. The old public key is no longer valid and should not be used. The system may also update other relevant information, such as the key version or key metadata, to reflect the change in public keys. The replacement operation is performed by the system using the validated manifest file and the new public key. The system ensures the public key is updated correctly, and the update operation is successful.

In an embodiment, the system can rotate to an older key if it is valid and not on a blacklist. For example, if an update package includes an old public key, the system checks the validity of the old public key and ensures it is not on a blacklist. If the old public key is valid and not on a blacklist, the system replaces the current public key with the old public key. The system performs the necessary checks to ensure the old public key is authentic and trustworthy. The system updates the public key storage with the old public key. The old public key is used for future verification operations. The rotation to an older key allows for greater flexibility and adaptability in managing public keys. The system handles the rotation to an older key securely and efficiently, minimizing the risk of errors or security breaches. The system supports multiple key rotation operations, allowing it to handle different scenarios and use cases. The system ensures the public key is updated correctly, and the update operation is successful.

In an embodiment, the key rotation process works offline because the necessary information is stored in the update package. The update package, which includes the new public key, signature, and manifest file, can be stored on physical storage, such as a USB drive or CD/DVD. The system can access the update package from the physical storage device and perform the key rotation operation without requiring a network connection. The system uses the information in the manifest file and the signature to verify the authenticity of the new public key and then replaces the old public key with the new one. The offline capability of the key rotation process allows for greater flexibility and adaptability in managing public keys and is particularly useful in situations where a network connection is not available or reliable. The update package comprises the necessary information to perform the key rotation operation, including the new public key, signature, and manifest file, making it possible to perform the operation offline.

In an embodiment, a verification process includes determining that the signature was generated using the old private key corresponding to the old public key. Validation is performed using open secure socket layer (OpenSSL) in an embodiment. This involves receiving instructions from a user to perform an operation related to one or more files in a file package. The system accesses a file package that comprises the new public key and the signature. The system identifies new version information associated with the new public key, such as a version number or timestamp. The system also identifies old version information associated with the old public key. The system then compares the new version information with the old version information to determine the course of action. Based on the comparison, the system initiates a key rotation operation. The system may determine whether the new public key is an update to the old public key or an older version. The system uses this information to decide whether or not to replace the old public key with the new public key.

### 5. MITIGATING TOCTOU ATTACKS

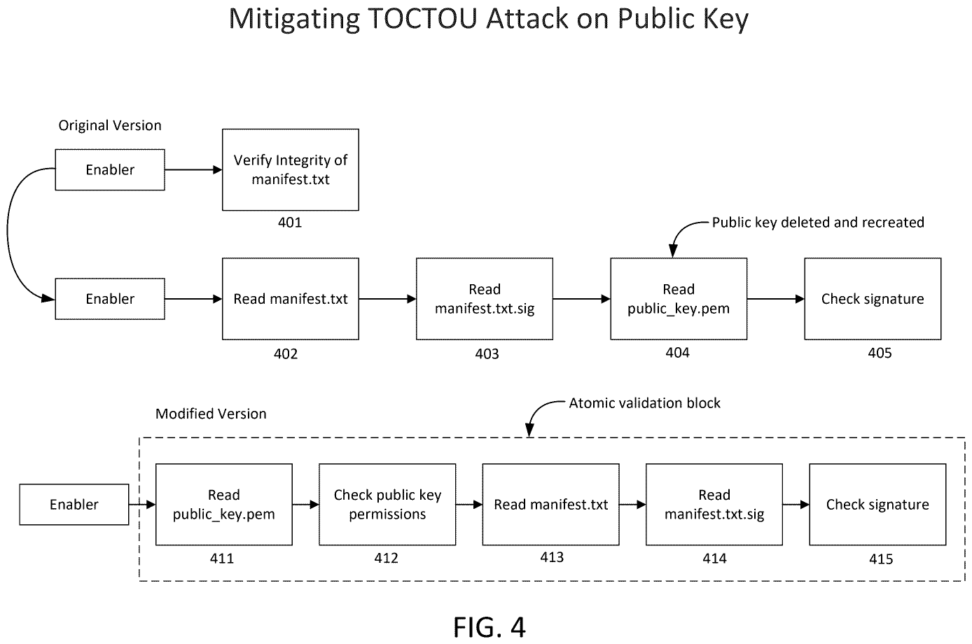

FIG. 4 illustrates an example set of operations for mitigating TOCTOU attacks on public keys in accordance with one or more embodiments. One or more operations illustrated in FIG. 4 may be modified, rearranged, or omitted. Accordingly, the particular sequence of operations illustrated in FIG. 4 should not be construed as limiting the scope of one or more embodiments.

In an embodiment, the system verifies the integrity of manifest.txt, a manifest file as described above (Operation 401). The system verifies the integrity of the manifest file by checking its digital signature. The digital signature is generated using a private key and can be verified using a corresponding public key. The system uses the public key to verify the digital signature of the manifest file. The verification process ensures the manifest file has not been tampered with or altered during transmission.

In an embodiment, the system reads manifest.txt (Operation 402). The system determines a fully qualified path for manifest.txt by joining a predetermined base directory with the file name and rejecting any path traversal sequences. The system opens manifest.txt using a read-only file descriptor with flags that prevent following symbolic links and require the target to be a regular file. The system validates ownership and permissions prior to reading, and the system acquires a shared lock to prevent concurrent writers from modifying the file while it is being read. The system ingests the contents into memory in fixed-size blocks and computes a cryptographic digest over the exact byte sequence that will later be verified against a corresponding signature. The system canonicalizes line endings and character encoding only if the file format specification requires canonicalization for signature verification, and the system records metadata that includes file size, inode, device identifier, and last modification time to detect time-of-check to time-of-use anomalies.

In an embodiment, the system reads manifest.txt.sig, a signature corresponding to the manifest file (Operation 403). The system resolves manifest.txt.sig adjacent to FILE.txt, opens it with the same link and type restrictions, and reads the entire payload into memory. The system supports detached signatures encoded in either binary or Base64 and performs whitespace normalization limited to the signature container format while preserving the underlying signature bytes. The system parses an algorithm identifier and signature parameters from manifest.txt.sig and verifies the algorithm and key lengths are allowed by a policy table embedded with the executable. The system pairs manifest.txt.sig with the previously computed digest of FILE.txt and defers signature verification until the applicable public key has been validated and loaded.

In an embodiment, the system reads public_key.pem, a public key file used for checking signatures (Operation 404). The system resolves public_key.pem from a trusted location fixed by configuration and restricted to a single directory on a trusted volume. The system opens public_key.pem with the same safeguards against links and non-regular files, and the system verifies file ownership and mode bits to ensure that only an authorized account can modify the file. The system parses the PEM file to obtain either a SubjectPublicKeyInfo or an X.509 certificate and then extracts the public key. The system computes a fingerprint of the extracted key and compares the fingerprint to a reference value. The system rejects public_key.pem if the fingerprint, issuer constraints, key usage, or validity constraints do not match an expected value, and the system aborts signature verification if any of these checks fail.

One of the issues that can arise is that without additional controls in place, a bad actor with write access to the file system may delete public_key.pem and replace it with a different public key. This is problematic because the bad actor can also modify both the manifest.txt file and the manifest.txt.sig file. If the manifest.txt file and the manifest.txt.sig file can be altered, then the bad actor can cause the system to verify the altered manifest using the attacker's substituted public key and accept the altered signature. As a result, the bad actor can trick the enabler into installing any files listed in the altered manifest, including malicious files, both at initial installation and during subsequent update cycles.

In an embodiment, the system checks the signature (Operation 405). The system checks the signature by using the public key it already validated and the hash it already computed for manifest.txt. The system verifies the signature against the exact bytes that were read without changing newlines or character encoding, and the system confirms the algorithm and key length are on an allow list. Without modification, this would appear valid. However, if someone tampered with or replaced the public key and altered the manifest.txt file and manifest.txt.sig file, the verification method could succeed.

In an embodiment, a modified flow performs steps 411-415 as an atomic validation block, mitigating the TOCTOU risk associated with the public key. The system opens manifest.txt using a read-only file descriptor with flags that prevent following symbolic links and require the target to be a regular file (Operation 411). The file descriptor provides a secure way to access the file, for it remains in memory and cannot be swapped out or replaced by an attacker. By using a file descriptor, the system ensures it is working with the original file, and any changes made to the file on disk do not affect the file descriptor. This approach mitigates TOCTOU attacks, for the system is not relying on the file name or path to access the file. The file descriptor remains open for the duration of the validation process, ensuring the system is working with the original file.

To further ensure the integrity of the update process, the system performs a series of checks to verify the authenticity and integrity of the replacement files. These checks include verifying the digital signature of the manifest file, checking the hashes of the replacement files, and verifying the permissions and ownership of the files. By performing these checks, the system can detect and prevent any attempts to tamper with the update process, ensuring the update is performed securely and efficiently.

In an embodiment, the system checks the permissions of the public key (Operation 412). If a bad actor swaps out the public key for a new one, the file will no longer be a root-owned file. By checking the permissions of the public key, the system can determine if the key has been tampered with or replaced, since the key that has been tampered with or replaced will be owned by the user account instead of a root account.

In an embodiment, the system reads manifest.txt (Operation 413). The system reads the file manifest.txt to obtain information about the replacement files. The file manifest.txt comprises a list of files that need to be updated along with their corresponding hashes and other metadata. The system reads the file manifest.txt to identify the root-owned files that require updating. The system also reads the file manifest.txt to verify the hashes of the replacement files. The system reads the file manifest.txt to determine the correct replacement files to update. The system reads the file manifest.txt to support the update operation. The system may read the file manifest.txt from a storage device or a network location. The system may read the file manifest.txt using a file reading module or a network reading module.

In an embodiment, the system reads manifest.txt.sig (Operation 414). The system reads the file manifest.txt.sig to obtain the digital signature of the manifest.txt file. The file manifest.txt.sig comprises the digital signature of the manifest.txt file generated using a digital signature algorithm. The system reads the file manifest.txt.sig to verify the authenticity of the manifest.txt file. The system reads the file manifest.txt.sig to ensure the manifest.txt file has not been tampered with or altered during transmission. The system reads the file manifest.txt. sig to support the validation of the manifest.txt file. The system may read the file manifest.txt. sig from a storage device or a network location. The system may read the file manifest.txt.sig in a sequential manner or in a random access manner. The system may read the file manifest.txt.sig using a file reading module or a network reading module.

In an embodiment, the system checks the signature (Operation 415). In an embodiment, the system checks the signature. The system uses a digital signature verification module to verify the digital signature comprised in manifest.txt.sig. The digital signature verification module uses the public key associated with the private key used to generate the digital signature to verify the authenticity of the manifest.txt file. The system checks the digital signature to ensure it matches the expected signature for the manifest.txt file. The system checks the digital signature to ensure it has not been tampered with or altered during transmission. The system checks the digital signature to support the validation of the manifest.txt file. The system may use a specific algorithm or protocol to verify the digital signature. The system may use a specific key pair or certificate to verify the digital signature.

In an embodiment, these steps are performed as an atomic operation. An atomic operation is a single, indivisible operation executed as a single, uninterruptible unit of work. The system ensures the steps of reading manifest.txt, reading manifest.txt.sig, and checking the signature are performed as a single, atomic operation. This means the system does not allow any other operation to interrupt or modify the execution of these steps while they are being performed. The system may use a specific mechanism or protocol to ensure these steps are performed as an atomic operation. The system may use a specific locking mechanism or synchronization primitive to ensure these steps are performed as an atomic operation.

In an embodiment, performing operations 411-415 as an atomic operation mitigates the risk of a TOCTOU attack on the public key by ensuring the system reads the manifest.txt and manifest.txt.sig files and verifies the digital signature, in a single, uninterruptible operation. This is achieved through the use of file descriptors that are unique identifiers assigned to open files by the operating system. When the system reads the manifest.txt and manifest.txt.sig files, the system opens a file descriptor for each file that allows the system to access the files in a controlled manner.

The use of file descriptors provides several benefits in the context of TOCTOU attacks. One, it ensures that the system is working with the original files rather than potentially malicious substitutes. When the system opens a file descriptor, it is guaranteed to be working with the file that existed at the time the descriptor was created rather than a file that may have been replaced by an attacker. Two, the use of file descriptors allows the system to detect any attempts to swap out the files between the time the system checks the file's existence and the time it verifies the digital signature. If an attacker attempts to swap out the files, the system will detect the change and reject the update, preventing the public key from being compromised.

In addition to the use of file descriptors, the system also uses other mechanisms to ensure the integrity of the update process. For example, the system may use a locking mechanism to prevent multiple processes from accessing the files simultaneously, which could potentially allow an attacker to swap out the files. The system may also use a checksum or hash of the files to verify their integrity, which would detect any changes to the files that may have been made by an attacker. By combining these mechanisms, the system is able to provide a high level of assurance that the public key is not compromised by a TOCTOU attack, and the update process is secure and reliable.

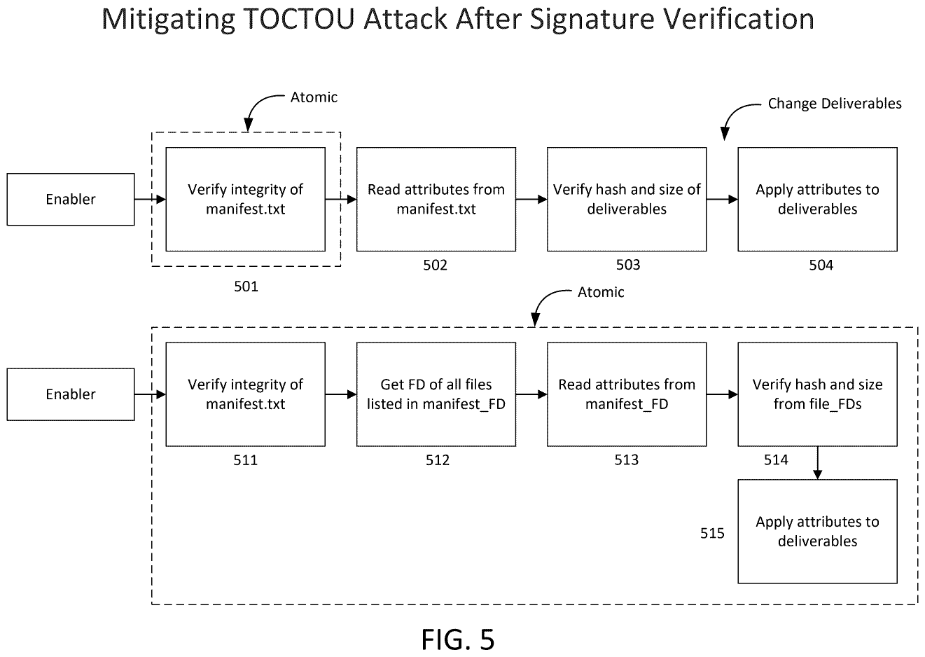

FIG. 5 illustrates an example set of operations for mitigating TOCTOU attacks after signature verification in accordance with one or more embodiments. One or more operations illustrated in FIG. 5 may be modified, rearranged, or omitted. Accordingly, the particular sequence of operations illustrated in FIG. 5 should not be construed as limiting the scope of one or more embodiments.

In an embodiment, the system verifies the integrity of manifest.txt (Operation 501). The system reads the contents of manifest.txt and calculates a hash value using a cryptographic hash function such as SHA-256. The system then compares the calculated hash value with the expected hash value stored in the manifest.txt file. If the calculated hash value matches the expected hash value, the system verifies the contents of manifest.txt have not been tampered with or altered during transmission.

In an embodiment, the system reads the attributes from manifest.txt (Operation 502). The system reads the contents of manifest.txt and extracts the attributes, such as the file names, sizes, and hashes, of the deliverables. The system stores these attributes in a data structure, such as a hash table or an array, for later use.

In an embodiment, the system verifies the hash and size for each deliverable (Operation 503). The system reads the attributes extracted in Operation 502 and verifies the hash and size of each deliverable by comparing them with the expected values stored in the manifest.txt file. If any of the deliverables have been tampered with or altered during transmission, the system will detect the discrepancy and reject the update.

In an embodiment, the system applies the desired attributes to the deliverables (Operation 504). The system reads the attributes extracted in Operation 502 and applies the desired attributes, such as the file names, sizes, and hashes, to the deliverables. The system may also perform additional operations, such as copying or moving the deliverables to their final destination or updating the file system metadata.

In an embodiment, the system verifies the integrity of manifest.txt and then reads the attributes from manifest.txt, creating a window of opportunity for an attacker to modify the deliverables. The system may not detect the modification because it has already verified the integrity of manifest.txt and may verify the hash and size of each deliverable after modifying the deliverables. The system's process of verifying the integrity of manifest.txt and then reading the attributes from manifest.txt may not detect the modification because it has already verified the integrity of manifest.txt and may not detect the modification because it has already read the attributes from manifest.txt. The system's failure to detect the modification may allow the attacker to exploit the system, potentially leading to unauthorized changes to the deliverables.

In an embodiment, to mitigate the opportunity for a TOCTOU attack after signature verification, the system performs operations 511-515 as an atomic operation. The system verifies the integrity of manifest.txt (Operation 511). The system calculates a hash value of the manifest.txt file and compares it with the expected hash value stored in the system. If the calculated hash value matches the expected hash value, the system verifies the manifest.txt file has not been tampered with or altered during transmission. The system uses a cryptographic hash function to calculate the hash value of the manifest.txt file. The system stores the expected hash value in a secure location to prevent tampering. The system verifies the integrity of the manifest.txt file to ensure it has not been modified or corrupted during transmission.

In an embodiment, the system gets the file descriptor for the files listed in the manifest file descriptor (Operation 512). The system opens a file descriptor for each file listed in the manifest file descriptor, allowing it to access the files and perform operations on them. The system uses the file descriptor to read and write data to the files. The system can use the file descriptor to perform different operations, such as reading, writing, and deleting files. The system can also use the file descriptor to check the existence of files and directories. The system can use the file descriptor to perform other operations on the files and directories.

In an embodiment, the system reads attributes from the manifest file descriptor (Operation 513). The system extracts the attributes, such as file names, sizes, and hashes, from the manifest file descriptor and stores them in a data structure for later use. The system uses the attributes to determine the files and directories that need to be updated or modified. The system can use the attributes to determine the permissions and access rights for the files and directories. The system can use the attributes to determine the file system and directory structure. The system can use the attributes to perform other operations on the files and directories.

In an embodiment, the system verifies the hash and size from the file descriptors associated with the files listed in the manifest (Operation 514). The system calculates the hash value of each file and compares it with the expected hash value stored in the system. The system also verifies the size of each file by comparing it with the expected size stored in the system. If any of the files have been tampered with or altered during transmission, the system will detect the discrepancy. The system uses the hash value and size to verify the integrity of the files. The system can use the hash value and size to detect any changes or modifications made to the files.

In an embodiment, the system applies the attributes requested in the manifest to the deliverables (Operation 515). The system uses the attributes extracted in Operation 513 to apply the desired attributes to the deliverables, such as renaming files or updating file permissions. The system can use the attributes to perform other operations on the deliverables. The system can use the attributes to determine the file system and directory structure. The system can use the attributes to perform other operations on the files and directories. The system applies the attributes to the deliverables to ensure they are updated or modified correctly.

Performing these steps as an atomic operation mitigates a potential TOCTOU attack by ensuring the system does not allow any intermediate state of the operation to be observed by an attacker. In other words, the system ensures the operation is either completely successful or completely failed without allowing any partial or intermediate state to be accessed by an attacker.

This is achieved by performing the steps as a single, uninterruptible unit, which means that the system does not allow any other process or thread to interrupt or modify the operation while it is being performed. This ensures the system does not allow any intermediate state of the operation to be observed by an attacker, which would allow the attacker to exploit the system and perform a TOCTOU attack.

By performing the steps as an atomic operation, the system ensures the operation is either completely successful or completely failed, which means that the system does not allow any partial or intermediate state to be accessed by an attacker. This ensures that the system is protected against TOCTOU attacks, and the integrity of the system is maintained.

In addition, performing the steps as an atomic operation also ensures the system does not allow any other process or thread to interfere with the operation while it is being performed. This means the system does not allow any other process or thread to modify or access the files or directories being updated, ensuring the system is protected against TOCTOU attacks and the integrity of the system is maintained.

### 6. EXAMPLE EMBODIMENTS

A detailed example is described below for purposes of clarity. Components and/or operations described below should be understood as one specific example which may not be applicable to certain embodiments. Accordingly, components and/or operations described below should not be construed as limiting the scope of any of the claims.

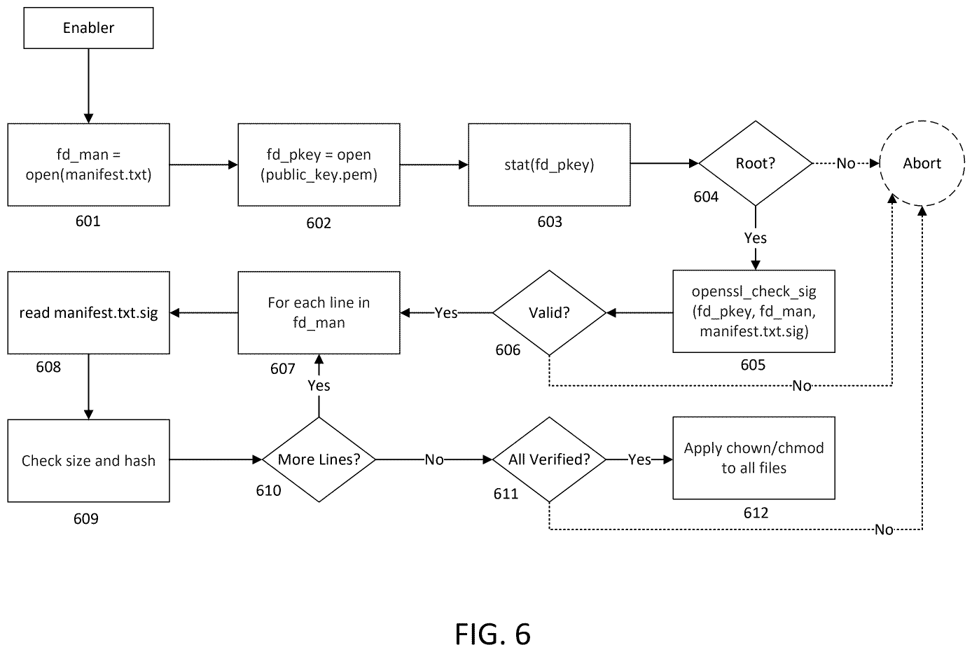

FIG. 6 illustrates an example set of operations for updating root-owned files in accordance with one or more embodiments. One or more operations illustrated in FIG. 6 may be modified, rearranged, or omitted. Accordingly, the particular sequence of operations illustrated in FIG. 6 should not be construed as limiting the scope of one or more embodiments.

In an embodiment, the system executes the command fd_man=open(manifest.txt) (Operation 601). The variable fd_man is assigned the result of the open function used to open a file. The open function takes a file name as an argument and returns a file descriptor that is a unique identifier for the file. In this specific case, the file name is manifest.txt, and the resulting file descriptor is assigned to the variable fd_man. This means that fd_man is a file descriptor that represents the file manifest.txt, and it can be used to read or write to that file. The open function is used to establish a connection to the file, allowing the system to interact with it and perform various operations, such as reading, writing, or modifying its contents.

In an embodiment, the system executes the command fd_pkey=open(public_key.pem) to open the public key file public_key.pem (Operation 602).

The system opens the public key file public_key.pem and assigns the resulting file descriptor to the variable fd_pkey. The open function takes the file name public_key.pem as an argument and returns a file descriptor that is a unique identifier for the file. The file descriptor fd_pkey represents the public key file public_key.pem, and it can be used to read or write to that file. The open function is used to establish a connection to the file, allowing the system to interact with it and perform numerous operations, such as reading, writing, or modifying its contents.

In an embodiment, the system executes the command stat(fd_pkey) (Operation 603). The stat command is used to retrieve information about the public key file public_key.pem represented by the file descriptor fd_pkey. The stat command returns a structure that comprises information about the file, such as its ownership, permissions, and other attributes.

In an embodiment, the system checks ownership of the public key to see if the public key is owned by root (Operation 604). The system uses the stat command to retrieve information about the public key file, including its ownership and permissions. The system then compares the ownership information to a trusted entity, such as the root user, to determine if the public key is owned by a trusted entity. If the public key is owned by the trusted entity, the system verifies that the public key is trusted and can be used to verify the digital signature of the manifest file. If the public key is owned by root, then the flow continues to operation 605. If the public key is not owned by root, then the process aborts.

In an embodiment, the system executes the command openssl_check_sig(fd_pkey, fd_man, manifest.txt.sig) (Operation 605). This command is used to verify the digital signature of the manifest file manifest.txt.sig using the public key stored in the file descriptor fd_pkey. The system utilizes the OpenSSL library or module to perform the signature verification process, which involves comparing the digital signature of the manifest file with the expected signature calculated using the public key. The command takes three arguments: the public key file descriptor fd_pkey, the manifest file descriptor fd_man, and the digital signature file manifest.txt.sig.

In an embodiment, the system uses the openssl_check_sig command to verify the integrity of the manifest file by ensuring that the digital signature matches the expected signature (Operation 606). If the digital signature matches, the system verifies the manifest file has not been tampered with or altered during transmission, and the flow continues to operation 607. If the system determines that the manifest file has been tampered with or altered, the validation process aborts.

In an embodiment, the system begins a loop to check each line in the manifest file (Operation 607). This loop is used to verify the integrity of the manifest file by checking each line individually. For each line, the system reads the manifest.txt.sig file (Operation 608) to obtain the digital signature of the manifest file. The digital signature is a cryptographic hash of the manifest file's contents, which is used to verify the file's integrity.

The system then checks the size and the hash of the digital signature (Operation 609) to ensure it matches the expected size and hash. The expected size and hash are calculated by the system using the same cryptographic hash function used to generate the digital signature. If the actual size and hash of the digital signature match the expected size and hash, the system verifies the manifest file has not been tampered with or altered during transmission.

This process is repeated for each line in the manifest file (Operation 610), allowing the system to verify the integrity of the entire file. By checking each line individually, the system can detect any changes or modifications made to the manifest file, ensuring the file remains intact and trustworthy.

In an embodiment, the system determines if all the files referred to in the manifest have been verified (Operation 611). This step is used to ensure that all the files listed in the manifest have been successfully verified and are trustworthy. If all the files have been verified, the system applies the chown and chmod commands to all the files (Operation 612). This step is used to set the ownership and permissions of the files to the desired values, ensuring they are properly configured and secure.

If the files have not all been verified, the verification process aborts. This step is used to prevent the system from proceeding with the verification process if any of the files listed in the manifest have not been successfully verified. By aborting the verification process, the system ensures the integrity of the files is maintained, and any potential security risks are minimized.

The system uses a verification process to check the integrity of the files listed in the manifest. This process involves checking the digital signature of each file to ensure it matches the expected signature. If the digital signature matches, the system verifies the file has not been tampered with or altered during transmission. If any of the files fail to verify, the system aborts the verification process to prevent any potential security risks.

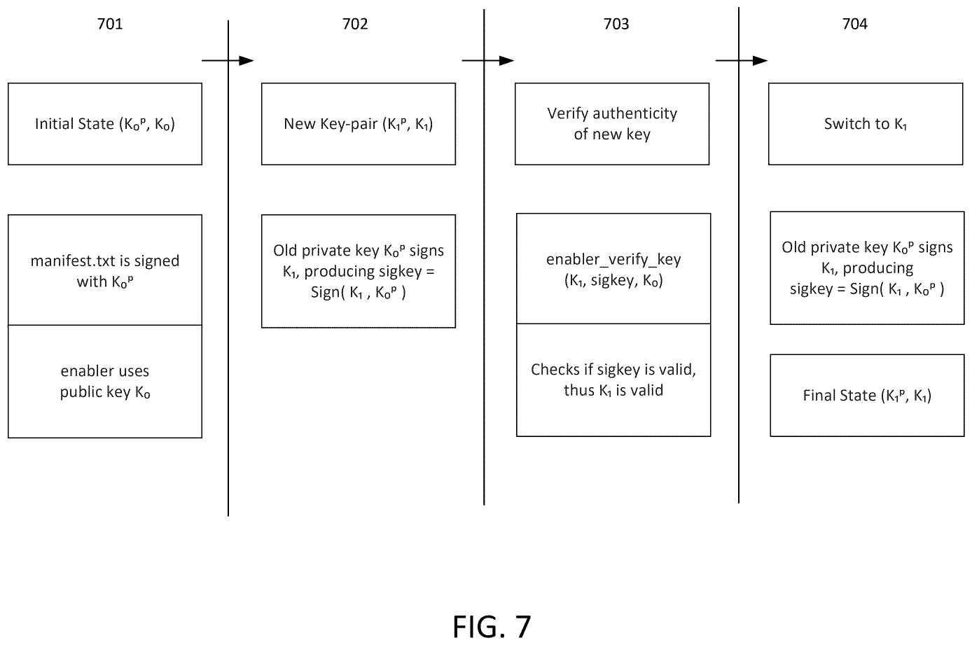

FIG. 7 illustrates an example set of operations for key rotation in accordance with one or more embodiments in accordance with one or more embodiments. One or more operations illustrated in FIG. 7 may be modified, rearranged, or omitted. Accordingly, the particular sequence of operations illustrated in FIG. 7 should not be construed as limiting the scope of one or more embodiments.

In an embodiment, the system starts at state 701. In this initial state, the system is using a key pair comprising a private key K₀^{p} and a public key K₀. The public key K₀ is used to verify the digital signature of the manifest file. The manifest file is signed with the private key K₀^{p}, which is used to generate the digital signature. The system is currently using the public key K₀ to verify the digital signature of the manifest file. This means the system trusts the public key K₀ to verify the integrity of the manifest file.

In an embodiment, the digital signature is a unique code generated using the private key K₀^{p} and attached to the manifest file. The public key K₀ is used to verify the digital signature is valid and has not been tampered with or altered during transmission. In this state, the system is relying on the public key K₀ to ensure the manifest file has not been modified or corrupted in any way. The public key is used to verify the digital signature of the manifest file, providing a secure way to ensure the integrity of the file.

In an embodiment, the system progresses to state 702. In this state, a new key pair is generated, comprising a private key K₁^{p} and a public key K₁. The private key K₁^{p} is used to generate a digital signature, and the public key K₁ is used to verify the digital signature. The old private key K₀^{p} is used to sign the new key pair, producing a digital signature sigkey=Sign(K₁, K₀^{p} This digital signature is used to verify the authenticity of the new key pair. To clarify, the old private key K₀^{p} is used to generate a digital signature attached to the new key pair. This digital signature is then used to verify the new key pair is authentic and has not been modified or corrupted. The public key K₁ is used to verify the digital signature, providing an additional layer of security and ensuring the new key pair is trusted and valid.

In an embodiment, the system progresses to state 703. In this state, the system verifies the authenticity of the new key pair using the enabler_verify_key function. The function takes three arguments: the new public key K₁, the digital signature sigkey, and the old private key K₀^{p}. The function checks if the digital signature sigkey is valid, meaning that the signature was generated using the old private key K₀^{p}. If the signature is valid, then the new key pair K₁^{p}, K₁ is authentic and can be trusted. This ensures the new key pair has not been tampered with or altered during transmission, and that it is a genuine and trusted key pair. In other words, the system is verifying the digital signature sigkey was generated using the old private key K₀^{p} , which is a trusted and authentic key. If the signature is valid, then the new key pair K₁^{p} , K₁ is also trusted and authentic, and the system can proceed to use it to verify the digital signature of the manifest file.

In an embodiment, the system progresses to state 704. In this final state, the system switches to using the new key pair K₁^{p} , K₁. The old private key K₀^{p} is no longer used, and the new public key K₁ is used to verify the digital signature of the manifest file. The system also generates a new digital signature using the new private key K₁^{p} and the new public key K₁. This digital signature is used to verify the integrity of the manifest file. The system is now using the new key pair K₁^{p} , K₁ to verify the digital signature of the manifest file, meaning the system trusts the new public key K₁ to verify the integrity of the manifest file. The system will continue to use the new key pair K₁^{p}, K₁ until a new key update is performed. The system is no longer relying on the old key pair K₀^{p} to verify the digital signature of the manifest file. Instead, the system is now using the new key pair K₁^{p}, K₁ to ensure the integrity of the file. This provides an additional layer of security and ensures the manifest file remains trustworthy and authentic.

In an embodiment, the key rotation process discussed in connection with states 701-704 works offline, allowing for secure key updates even when a file package is accessed via an offline source such as a USB stick. Specifically, the system uses a secure key generation process executed locally on the device without relying on any network connections. This is achieved through the use of a secure key generation and verification process that does not require network connectivity. The system ensures any unauthorized access and tampering of the key pair is detected even in the absence of a network connection. This eliminates the need for network connectivity, making it possible to update key pairs offline.

### 7. PRACTICAL APPLICATIONS, ADVANTAGES, AND IMPROVEMENTS

Embodiments provide several practical applications, advantages, and improvements over existing key management systems. These advantages and improvements include the following:

Improved Security: Embodiments provide improved security by allowing non-root users to update root-owned files securely. This ensures that sensitive files are protected from unauthorized access and modification. The system uses a secure key generation process executed locally on the device without relying on any network connections. This eliminates the need for manual intervention by a root user, reducing the risk of human error. Additionally, the system ensures that any unauthorized access and tampering of the key pair is detected even in the absence of a network connection.

Increased Efficiency: Embodiments provide increased efficiency by allowing users to update their key pairs offline. This eliminates the need for network connectivity, making it possible to update key pairs in scenarios where network connectivity is unreliable or unavailable. The system uses a secure key generation and verification process that does not require network connectivity, ensuring that key pairs are updated securely and efficiently. This reduces the time and resources required to update key pairs, making it possible to update key pairs more frequently. Additionally, the system ensures that key pairs are updated consistently and reliably even in the absence of a network connection.

Enhanced Trust: Embodiments provide enhanced trust by using a secure key generation and verification process. This ensures that key pairs are generated and verified securely even in the absence of a network connection. The system uses a secure key generation process executed locally on the device without relying on any network connections. This eliminates the need for manual intervention by a root user, reducing the risk of human error. Additionally, the system ensures that any unauthorized access and tampering of the key pair is detected even in the absence of a network connection.

One or more embodiments improve the functioning of a key management system by providing a secure method for updating key pairs offline. This improvement provides a technical benefit by ensuring the security and integrity of the key pair. The system ensures that key pairs are updated securely and efficiently even in the absence of a network connection. This reduces the time and resources required to update key pairs, making it possible to update key pairs more frequently. Additionally, the system ensures that key pairs are updated consistently and reliably even in the absence of a network connection.

In an embodiment, the system allows non-root users to update root-owned files securely, providing a more efficient and secure method for managing sensitive files. This improvement provides a more secure method for updating root-owned files, for it eliminates the need for manual intervention by a root user. The system uses a secure key generation process executed locally on the device without relying on any network connections. This eliminates the need for manual intervention by a root user, reducing the risk of human error. Additionally, the system ensures that any unauthorized access and tampering of the key pair is detected even in the absence of a network connection.

One or more embodiments improve the functioning of a key management system by providing a secure method for updating key pairs offline. This improvement provides a technical benefit by ensuring the security and integrity of the key pair. The system ensures that key pairs are updated securely and efficiently even in the absence of a network connection. This reduces the time and resources required to update key pairs, making it possible to update key pairs more frequently. Additionally, the system ensures that key pairs are updated consistently and reliably even in the absence of a network connection.

In an embodiment, the system provides a secure method for updating key pairs offline, providing a more efficient and secure method for managing sensitive files. This improvement provides a more secure method for updating key pairs, for it eliminates the need for network connectivity. The system uses a secure key generation process executed locally on the device without relying on any network connections. This eliminates the need for manual intervention by a root user, reducing the risk of human error. Additionally, the system ensures that any unauthorized access and tampering of the key pair is detected even in the absence of a network connection.

### 8. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 9. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

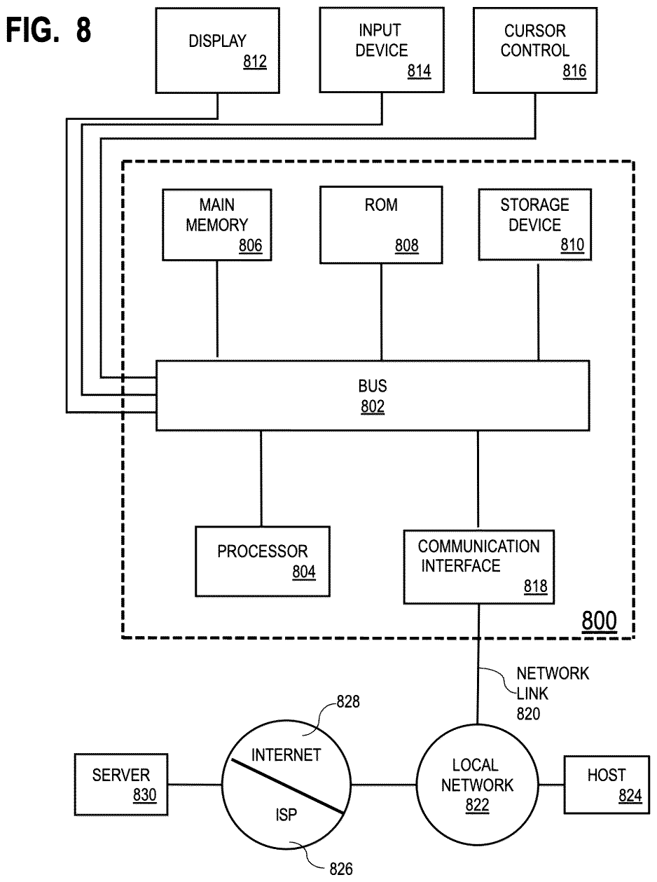

For example, FIG. 8 is a block diagram that illustrates a computer system 800 upon which an embodiment of the disclosure may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read-only memory (ROM) 808 or other static storage device coupled to bus 802 for storing static information and instructions for processor 804. A storage device 810, such as a magnetic disk, optical disk, or a Solid State Drive (SSD) is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### 10. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
receiving instructions from a first non-root user to perform a first update operation to a first set of one or more root-owned files;
wherein the first update operation comprises replacing the first set of root-owned files with a first set of one or more replacement files corresponding to the first set of root-owned files and associated with a first file package;
accessing the first file package, wherein the first file package comprises:
a) a first manifest file; and
b) a first replacement file;
wherein the first manifest file is signed with a first signature corresponding to a first private key;
performing a first validation operation on the first manifest file by comparing the first signature with a first public key corresponding to the first private key;
determining, based on the first validation operation, that the first manifest file is valid;
responsive to determining that the first manifest is valid, updating a first root-owned file of the first set of root-owned files by replacing the first root-owned file with the first replacement file; and
wherein the method is performed by at least one device including a hardware processor.

2. The method of claim 1, wherein the first manifest file identifies the first replacement file and a first hash corresponding to the first replacement file.

3. The method of claim 1, further comprising:
generating a first computed hash for the first replacement file; and
wherein the first validation operation further comprises verifying that the first computed hash of the first replacement file matches a first manifest hash listed in the first manifest file, the first manifest hash corresponding to the first replacement file.

4. The method of claim 1, further comprising:
receiving instructions from a second non-root user to perform a second update operation to a second set of one or more root-owned files;
wherein the second update operation comprises replacing the second set of root-owned files with a second set of one or more replacement files corresponding to the second set of root-owned files and associated with a second file package;
accessing the second file package, wherein the second file package comprises:
a) a second manifest file; and
b) a second replacement file;
wherein the first manifest file is signed with a second signature corresponding to a second private key;
performing a second validation operation on the second manifest file by determining permissions associated with a second public key corresponding to the second private key;
determining, based on the second validation operation, that the second public key is not a root-owned file; and
responsive to determining that the second public key is not a root-owned file, terminating the second validation operation.

5. The method of claim 1, wherein the first manifest file comprises, for each replacement file of the first set of replacement files:
a corresponding hash;
a corresponding file size;
a corresponding install location that indicates a file to overwrite; and
an image location that identifies the replacement file.

6. The method of claim 5, wherein the first validation operation further comprises:
opening a file descriptor for each replacement file identified in the first manifest file;
computing a hash of each replacement file using the file descriptor;
comparing the computed hash for each replacement file with the corresponding hash listed in the manifest file; and
responsive to determining that the computed hash matches the corresponding hash, performing the first update operation.

7. The method of claim 5, wherein the first validation operation further comprises:
opening a file descriptor for each replacement file identified in the manifest file;
computing a hash of each replacement file using the file descriptor;
comparing the computed hash for each replacement file with the corresponding hash listed in the manifest file; and
responsive to determining that the computed hash does not match the corresponding hash, aborting the first update operation.

8. The method of claim 1, wherein the first update operation is performed by an intermediary with root privileges.

9. The method of claim 8, wherein the first replacement file is a new version of the intermediary, and the update operation, performed by the intermediary on behalf of the non-root user, results in an update of the intermediary.

10. The method of claim 1, wherein the first replacement file is a root-owned file subsequent to the first update operation.

11. A method, comprising:
accessing a new public key and a signature generated using an old private key corresponding to an old public key, wherein the signature is associated with the new public key;
verifying the signature to determine if the new public key is authentic using:
a) the signature;
b) the old public key that corresponds to the old private key; and
c) the new public key;
responsive to determining that the new public key is authentic, replacing the old public key with the new public key; and
wherein the method is performed by at least one device including a hardware processor.

12. The method of claim 11, wherein verifying includes determining that the signature was generated using the old private key corresponding to the old public key.

13. The method of claim 11, further comprising:
receiving instructions from a user to perform an operation related to one or more files in a file package;
accessing a file package, wherein the file package comprises:
a) the new public key; and
b) the signature;
identifying new version information associated with the new public key;
identifying old version information associated with the old public key; and
based at least in part on a comparison between the new version information and the old version information, initiating a key rotation operation.

14. The method of claim 13, wherein the comparison between the new version information and the old version information indicates that the new public key is an older public key that the old public key.

15. The method of claim 14, further comprising:
determining that the new public key is associated with a blacklist that indicates the new public key has been compromised; and
in response to determining that the new public key is associated with the blacklist, terminating the key rotation operation.

16. The method of claim 11, wherein the signature is validated using OpenSSL.

17. The method of claim 11, wherein verifying comprises computing a hash of the new public key using a file descriptor associated with the new public key.

18. The method of claim 11, wherein the method is performed in an offline environment, without requiring a network connection.

19. One or more non-transitory computer-readable media comprising instructions that, when executed by one or more hardware processors, cause performance of operations comprising:
receiving instructions from a first non-root user to perform a first update operation to a first set of one or more root-owned files;
wherein the first update operation comprises replacing the first set of root-owned files with a first set of one or more replacement files corresponding to the first set of root-owned files and associated with a first file package;
accessing the first file package, wherein the first file package comprises:
a) a first manifest file; and
b) a first replacement file;
wherein the first manifest file is signed with a first signature corresponding to a first private key;
performing a first validation operation on the first manifest file by comparing the first signature with a first public key corresponding to the first private key;
determining, based on the first validation operation, that the first manifest file is valid;
responsive to determining that the first manifest is valid, updating a first root-owned file of the first set of root-owned files by replacing the first root-owned file with the first replacement file.

20. The computer-readable media of claim 19, wherein the operations further comprise:
receiving instructions from a second non-root user to perform a second update operation to a second set of one or more root-owned files;
wherein the second update operation comprises replacing the second set of root-owned files with a second set of one or more replacement files corresponding to the second set of root-owned files and associated with a second file package;
accessing the second file package, wherein the second file package comprises:
a) a second manifest file; and
b) a second replacement file;
wherein the first manifest file is signed with a second signature corresponding to a second private key;
performing a second validation operation on the second manifest file by determining permissions associated with a second public key corresponding to the second private key;
determining, based on the second validation operation, that the second public key is not a root-owned file; and
responsive to determining that the second public key is not a root-owned file, terminating the second validation operation.
